(19) United States
(12) Patent Application Publication
(10) Pub. No.: US 2022/0153953 A1
(43) Pub. Date: May 19, 2022

(54) Hydrophobic/Oleophobic Material

(71) Applicant: Malvern Optical Limited, Worcestershire (GB)

(72) Inventors: Simon Childs, Droitwich (GB); Ben Allsopp, Stratford-upon-Avon (GB)

(73) Assignee: Malvern Optical Limited, Worcestershire (GB)

(21) Appl. No.: 17/529,572

(22) Filed: Nov. 18, 2021

(30) Foreign Application Priority Data
Nov. 18, 2020 (GB) 2018146.7

(51) Int. Cl. C08J 9/42; C09D 127/12; C09D 183/08; C09D 7/40; C09D 7/61; C09D 7/20

(52) U.S. Cl. CPC C08J 9/42; C09D 127/12; C09D 183/08; C09D 7/67; C08J 2483/08; C09D 7/20; C08J 2205/05; C08J 2427/12; C09D 7/61

(57) ABSTRACT

A method of manufacturing a hydrophobic/oleophobic material comprises providing an open cell structure having a plurality of interconnected cells and providing a resin solution containing nanoparticles. The resin solution containing nanoparticles is introduced into, and is cured within, the interconnected cells of the open cell structure. By curing the resin solution containing nanoparticles within the interconnected cells of the open cell structure, a highly hydrophobic/oleophobic material can be produced which exhibits isotropic properties.

### CROSS-REFERENCE TO RELATED APPLICATION

This application claims the benefit of and priority from UK Patent Application No. 2018146.7, filed on Nov. 18, 2020 in the UK Intellectual Property Office. The United Kingdom application is incorporated herein by reference, in entirety.

### FIELD

The present invention relates to hydrophobic/oleophobic materials.

### BACKGROUND

Hydrophobicity and oleophobicity are the physical properties of being highly repellent (or, more accurately, weakly attracted) to water and oil, respectively. The term “hydrophobic/oleophobic” is used herein to refer to materials exhibiting hydrophobic properties or oleophobic properties, or both hydrophobic and oleophobic properties.

Hydrophobic/oleophobic substances, on their own, can often lack the desired structural properties for use in certain applications. For this reason, hydrophobic/oleophobic materials are typically manufactured by applying a surface layer of a hydrophobic/oleophobic substance onto a substrate which does have the desired structural properties. If the surface layer of the material becomes damaged, for example by impact, scratching or peeling, this can expose the underlying substrate and severely impair the hydrophobicity/oleophobicity of the material.

### BRIEF DESCRIPTION

It is desired to provide improvements relating to hydrophobic/oleophobic materials.

Thus, according to an aspect of the present invention there is provided a method of manufacturing a hydrophobic/oleophobic material comprising: providing an open cell structure having a plurality of interconnected cells; providing a resin solution containing nanoparticles; introducing the resin solution containing nanoparticles into the interconnected cells of the open cell structure; and curing the resin solution containing nanoparticles within the interconnected cells of the open cell structure.

According to another aspect of the present invention there is provided a hydrophobic/oleophobic material comprising: an open cell structure having a plurality of interconnected cells, the interconnected cells of the open cell structure having therewithin a cured resin solution containing nanoparticles.

The Applicants have identified that, by curing a resin solution containing nanoparticles within the interconnected cells of an open cell structure, a highly hydrophobic/oleophobic material can be produced. Furthermore, the material can exhibit isotropic properties. For example, the material can remain hydrophobic/oleophobic even when the surface of the material is severely damaged.

In embodiments, the open cell structure may be provided as a sheet. Thus, the open cell structure may have a thickness which is significantly less than its width/length. The ratio of the thickness to the width and/or length may be 1:x, where x is at least 10, for example at least 20. The open cell structure may be formed of a polymer, such as polyurethane. The open cell structure may be an open cell foam structure. Thus, providing the open cell structure may comprise foaming and then setting a polymer. The open cell structure may have a cell density in the range 5-40 cells per cm, for example in the range 15-30 cells per cm. Prior to the resin solution being cured therewithin, the open cell structure may be resiliently compressible and expandable. As will be discussed in more detail below, resilient compression and expansion of the open cell structure can assist with drawing the resin solution containing nanoparticles into the interconnected cells.

The resin may comprise any desired and suitable, for example “low surface energy”, resin. The resin may, for example, comprise a fluoro resin, a siloxane resin, or a fluoro-siloxane resin. The resin solution may comprise 5-25% wt resin.

The resin solution may also comprise any desired and suitable solvent, for example which dissolves the resin but does not dissolve the nanoparticles and/or open cell structure. The solvent may comprise an organic solvent. The solvent may, for example, comprise acetone, butanone, xylene, isopropanol, ethyl acetate or propylene glycol methyl ether acetate. The resin solution may comprise 60-90% wt solvent.

The nanoparticles may also be formed of any desired and suitable, for example non-metallic or metallic, substance. The nanoparticles may, for example, be formed of silica (e.g. fumed silica), nickel and/or iron. The nanoparticles may have at least one dimension which is less than 100 nm. The nanoparticles may have at least one dimension which is in the range 1-100 nm, for example in the range 10-75 nm. The resin solution may comprise 5-15% wt nanoparticles.

In embodiments, providing the resin solution may comprise dissolving the resin in the solvent. Providing the resin solution containing nanoparticles may comprise adding the nanoparticles to the resin solution. The nanoparticles may be added to the solvent prior to, during and/or after the dissolving of the resin in the solvent. The method may further comprise mixing the resin solution containing nanoparticles. Mixing the resin solution containing nanoparticles may comprise high-shear mixing. These embodiments can help to ensure full dispersion of the nanoparticles throughout the resin solution.

In embodiments, introducing the resin solution containing nanoparticles into the interconnected cells may comprise immersing the open cell structure in the resin solution (e.g. in a container which holds the resin solution). This can allow the resin solution to be drawn into the interconnected cells by capillary action. Introducing the resin solution containing nanoparticles into the interconnected cells may further comprise compressing the open cell structure and then allowing the open cell structure to expand resiliently whilst immersed in the resin solution (e.g. whilst in the container which holds the resin solution). This can further help to draw the resin solution into the interconnected cells by creating a lower pore pressure. The open cell structure may be at least partially or substantially fully saturated with the resin solution following introduction of the resin solution containing nanoparticles into the interconnected cells of the open cell structure. The open cell structure may be removed from the resin solution (e.g. removed from the container which holds the resin solution) prior to curing the resin solution containing nanoparticles within the interconnected cells.

In embodiments, the method may further comprise removing an excess of resin solution from the open cell structure prior to curing the remaining resin solution within the interconnected cells. Removing an excess of resin solution may comprise allowing the excess resin solution to leave the open cell structure under gravity. Removing an excess of the resin solution may also or instead comprise compressing the open cell structure to force the excess resin solution to leave the open cell structure. Compressing the open cell structure to remove the excess of resin solution may be achieved using compression rollers and/or compression plates. Compressing the open cell structure can help to accelerate the process of removing the excess of resin solution from the open cell structure.

In embodiments, curing the resin solution containing nanoparticles within the interconnected cells may take place over a period of time in the range 12-36 hours, for example in the range 18-30 hours. Curing the resin solution containing nanoparticles within the interconnected cells may take place at a temperature in the range 5-45° C., for example in the range 15-35° C.

In embodiments, the method may further comprise compressing the open cell structure during and/or after the curing of the resin solution within the interconnected cells. This can help to make the resultant material tougher whilst still remaining flexible. Compressing the open cell structure during and/or after the curing of the resin solution within the interconnected cells may be achieved using compression rollers and/or compression plates. The compression ratio (i.e. thickness of the open cell structure prior to compression:thickness of the open cell structure after compression) used when compressing the open cell structure during and/or after the curing of the resin solution within the interconnected cells may be in the range 5:1-20:1, for example in the range 7:1-14:1. It has been identified that lower compression ratios can be undesirable since they may lead to the material expanding resiliently following the compression. It has also been identified that greater compression ratios can be undesirable since they may lead to a dense/smooth material having reduced hydrophobicity/oleophobicity. The thickness of the open cell structure prior to compression may be in the range 10 mm-75 mm, for example in the range 15 mm-50 mm. The compression ratio may be achieved using a predetermined applied pressure. The compression ratio may also or instead be achieved by a predetermined minimum spacing between compression rollers and/or compression plates. The predetermined minimum spacing between compression plates may be maintained using a shim between the compression plates, with the shim being substantially incompressible at the applied pressure.

In embodiments, compressing the open cell structure during and/or after the curing of the resin solution within the interconnected cells may take place over a time period in the range 1-7 minutes, for example in the range 3-5 minutes. Compressing the open cell structure during and/or after the curing of the resin solution within the interconnected cells may take place at a temperature in the range 125-200° C., for example in the range 150-175° C.

In embodiments, the method may further comprise abrading one or more surfaces of the material. This can help to roughen the surface of the material and thereby further improve the hydrophobicity/oleophobicity of the material and/or thereby modify its optical appearance, for example making it more matt in appearance.

It will be appreciated that the expression “hydrophobic/oleophobic” used herein is intended to encompass materials which are either hydrophobic or oleophobic, or are both hydrophobic and oleophobic. The term “hydrophobic” may indicate a contact angle for a surface water droplet of at least 90° at standard temperature and pressure, with a greater contact angle indicating greater hydrophobicity. Similarly, the term “oleophobic” may indicate a contact angle for a surface oil droplet of at least 90° at standard temperature and pressure, with a greater contact angle indicating greater oleophobicity.

### BRIEF DESCRIPTION OF THE FIGURES

By way of example only, embodiments of the invention will now be described in detail with reference being made to the accompanying drawings in which:

FIG. 1 illustrates a method of manufacturing a hydrophobic/oleophobic material according to an embodiment of the present invention;

FIG. 2 is a close-up view of a hydrophobic/oleophobic material according to an embodiment of the present invention taken with a scanning electron microscope; and

FIG. 3 shows a hydrophobic/oleophobic material according to an embodiment of the present invention with test liquid droplets thereon.

### DETAILED DESCRIPTION OF THE FIGURES

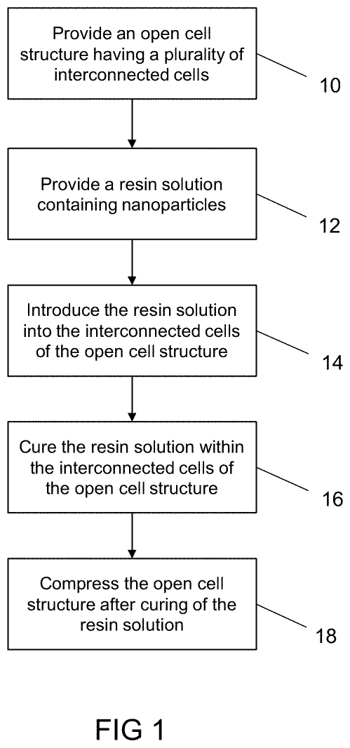

FIG. 1 illustrates a method of manufacturing a hydrophobic/oleophobic material. In step 10 of the method, an open cell structure having a plurality of interconnected cells is provided. In this embodiment, the open cell structure comprises a sheet of polyurethane foam having a thickness in the range 10 mm-75 mm and a cell density in the range 5-40 cells per cm.

In step 12, a resin solution containing nanoparticles is provided. The resin solution is prepared by dissolving a “low surface energy” fluoro, siloxane or fluoro-siloxane resin in an organic solvent such as acetone, butanone, xylene, isopropanol, ethyl acetate or propylene glycol methyl ether acetate. Nanoparticles having at least one dimension which is in the range 1-100 nm are added to the resin solution and thoroughly dispersed using a high-shear mixer. In this embodiment, the nanoparticles are formed of silica, nickel or iron, but other suitable substances could be used. In this embodiment, the resin solution comprises 5-25% wt resin, 60-90% wt solvent and 5-15% wt nanoparticles, for example 15 g resin, 85 g solvent and 10 g nanoparticles.

In step 14, the resin solution is introduced into the interconnected cells of the open cell structure by immersing the open cell structure in a container which holds the resin solution. The open cell structure is compressed and then allowed to expand resiliently whilst in the container in order to draw the resin solution into the open cell structure. The open cell structure is then removed from the container and an excess of resin solution is removed by a combination of dripping under gravity and gentle compression of the open cell structure using compression rollers or plates.

In step 16, the resin solution within the interconnected cells of the open cell structure is cured. In this embodiment, curing takes place over a period of time in the range 12-36 hours at a temperature in the range 5-45° C.

In step 18, the open cell structure is then compressed using compression rollers or plates. This can help to make the resultant material tougher whilst still remaining flexible. In this embodiment, the compression ratio is in the range 5:1-20:1. The desired compression ratio is achieved by spacing the rollers appropriately or by placing an appropriately sized shim between the compression plates. In this embodiment, the compression takes place over a period of time in the range 1-7 minutes at a temperature in the range 125-200° C. The surface of the material is then abraded to roughen the surface of the material and thereby further improve the hydrophobicity/oleophobicity of the material, and modify its optical appearance. Contact angles of ˜155° for water, ˜120° for engine oil and hydraulic fluid, and ˜95° for diesel, have been achieved by following the above method.

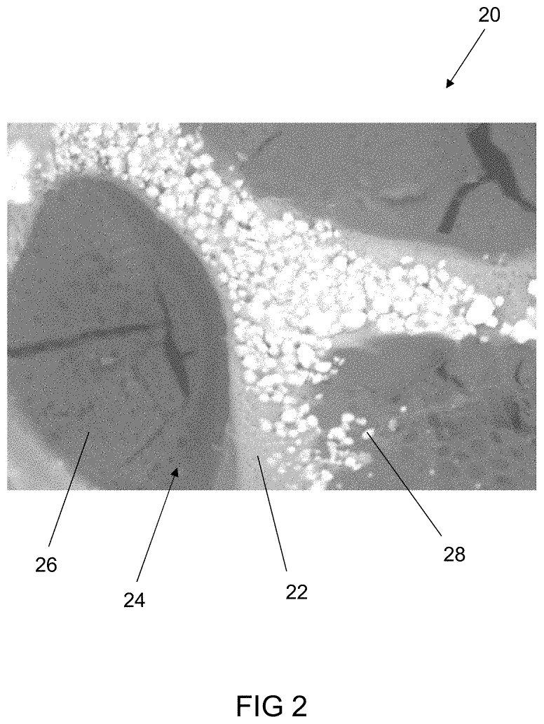

FIG. 2 is a close-up view of a hydrophobic/oleophobic material 20 formed using the above method. This view was obtained using a scanning electron microscope. As is shown, the material 20 has an open cell structure 22 having a plurality of interconnected cells 24. The interconnected cells 24 of the open cell structure 22 have a cured resin solution 26 containing nanoparticles 28 therewithin. The nanoparticles 28 in the region of the open cell structure 22 are most visible in this view, but the nanoparticles 28 are also dispersed throughout the cured resin 26.

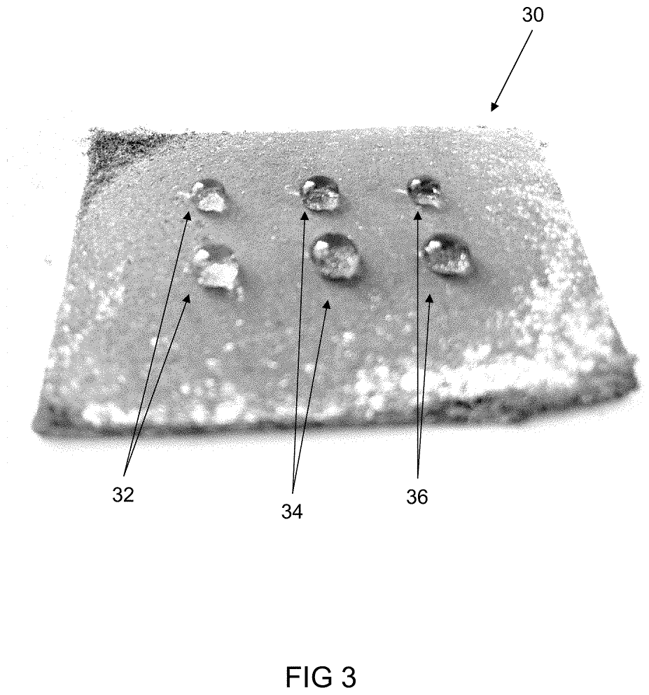

FIG. 3 also shows a hydrophobic/oleophobic material 30 formed using the above method. The material 30 has pairs of test liquid droplets thereon. The first pair of droplets 32 are engine oil, the second pair of droplets 34 are hydraulic fluid, and the third pair of droplets 36 are 2-stroke oil. The oleophobic nature of the material 30 is clearly evident from this FIG. 3 from the manner in which the droplets 32, 34, 36 sit on the surface of the material 30.

1. A method of manufacturing a hydrophobic/oleophobic material comprising: providing an open cell structure having a plurality of interconnected cells; providing a resin solution containing nanoparticles; introducing the resin solution containing nanoparticles into the interconnected cells of the open cell structure; and curing the resin solution containing nanoparticles within the interconnected cells of the open cell structure.

2. A method as claimed in claim 1, wherein the open cell structure is formed of a polymer.

3. A method as claimed in claim 1, wherein the open cell structure has a cell density in the range 5-40 cells per cm.

4. A method as claimed in claim 1, wherein, prior to the resin solution being cured therewithin, the open cell structure is resiliently compressible and expandable.

5. A method as claimed in claim 1, wherein the resin solution comprises 5-25% wt resin.

6. A method as claimed in claim 1, wherein the resin comprises a fluoro resin, a siloxane resin, or a fluoro-siloxane resin.

7. A method as claimed in claim 1, wherein the resin solution comprises an organic solvent.

8. A method as claimed in claim 1, wherein the resin solution comprises 60-90% wt solvent.

9. A method as claimed in claim 1, wherein the nanoparticles are metallic or non-metallic.

10. A method as claimed in claim 1, wherein the nanoparticles have at least one dimension in the range 1-100 nm.

11. A method as claimed in claim 1, wherein the resin solution comprises 5-15% wt nanoparticles.

12. A method as claimed in claim 1, wherein introducing the resin solution containing nanoparticles into the interconnected cells comprises immersing the open cell structure in the resin solution, and wherein introducing the resin solution containing nanoparticles into the interconnected cells further comprises compressing the open cell structure and then allowing the open cell structure to expand resiliently whilst immersed in the resin solution.

13. A method as claimed in claim 1, wherein the open cell structure is at least partially or substantially fully saturated with the resin solution following introduction of the resin solution containing nanoparticles into the interconnected cells of the open cell structure.

14. A method as claimed in claim 1, wherein the method further comprises removing an excess of resin solution from the open cell structure prior to curing the remaining resin solution within the interconnected cells, and wherein removing the excess of resin solution comprises at least one of i) allowing the excess resin solution to leave the open cell structure under gravity and ii) compressing the open cell structure to force the excess resin solution to leave the open cell structure.

15. A method as claimed in claim 1, wherein curing the resin solution containing nanoparticles within the interconnected cells takes place at least one of i) over a period of time in the range 12-36 hours and ii) at a temperature in the range 5-45° C.

16. A method as claimed in claim 1, wherein the method further comprises compressing the open cell structure at least one of i) during the curing of the resin solution within the interconnected cells and ii) after the curing of the resin solution within the interconnected cells.

17. A method as claimed in claim 16, wherein the compression ratio used when compressing the open cell structure is in the range 5:1-20:1.

18. A method as claimed in claim 16, wherein compressing the open cell structure takes place at least one of i) over a time period in the range 1-7 minutes and ii) at a temperature in the range 125-200° C.

19. A method as claimed in claim 1, wherein the method further comprises abrading one or more surfaces of the material.

20. A hydrophobic/oleophobic material comprising: an open cell structure having a plurality of interconnected cells, the interconnected cells of the open cell structure having a cured resin solution containing nanoparticles therewithin.
